(19) United States
(12) Patent Application Publication
(10) Pub. No.: US 2019/0195701 A1
(43) Pub. Date: Jun. 27, 2019

(54) CALIBRATION OF A CHIP-BASED MICROFLUIDIC CALORIMETER

(71) Applicant: TECHNISCHE UNIVERSITEIT DELFT, CN Delft (NL)

(72) Inventors: Kourosh HONARMAND EBRAHIMI, AA Delft (NL); Morten VAN SCHIE, AA Delft (NL); Peter Leon HAGEDOORN, AA Delft (NL); Wilfred Raymond HAGEN, AA Delft (NL)

(21) Appl. No.: 16/092,614

(22) PCT Filed: Apr. 13, 2017
(86) PCT No.: PCT/NL2017/050231

§ 371 Date: Oct. 10, 2018

(30) Foreign Application Priority Data
Apr. 15, 2016 (NL) 2016612

(51) Int. Cl. G01K 17/00; G01N 25/48; G01K 3/08; G01N 21/05

(52) U.S. Cl. CPC G01K 17/006; G01N 25/482; G01N 2021/0346; G01N 25/4873; G01N 21/05; G01K 3/08

(57) ABSTRACT

The invention provides a calibration method for calibrating a chip-based microfluidic calorimeter, wherein the chip-based microfluidic calorimeter comprises one or more thermopiles, wherein the calibration method uses the deprotonating reaction of a phosphate group, the method comprising: providing calibration liquids comprising (i) a buffer with a pH range of at least 7-9 and (ii) a first compound with a phosphate group which is protonated in a pH range of at least 3-6, and mixing these calibration liquids in the chip-based microfluidic calorimeter to provide a calibration liquid mixture whereby heat is generated, measuring the heat by the thermopiles and thereby providing a corresponding thermopile signal, and calibrating the chip-based microfluidic calorimeter by relating the thermopile signal to reference data of the deprotonating reaction.

### FIELD OF THE INVENTION

The invention relates to a method for the calibration of a chip-based microfluidic calorimeter. The invention also relates to such calibrated microfluidic calorimeter. Further, the invention relates to a kit of parts for calibration of a microfluidic calorimeter.

### BACKGROUND OF THE INVENTION

Calibration of calorimeters is known in the art. EP2678651 (WO2012116092A1), for instance, describes a MEMS-based calorimeter including two micro chambers supported in a thin film substrate is provided. The thin film substrate includes a thermoelectric sensor configured to measure temperature differential between the two micro chambers, and also includes a thermally stable and high strength polymeric diaphragm. Methods for fabricating the MEMS-based calorimeter, as well as methods of using the calorimeter to measure thermal properties of materials, such as biomolecules, or thermodynamic properties of chemical reactions or physical interactions, are also provided in EP2678651.

### SUMMARY OF THE INVENTION

Calorimetry is a measuring technique where reactions are analyzed by detecting the changes in heat they cause in a sample. In biochemistry, this method can be used to study a wide variety of phenomena, like binding reactions, microbial growth or enzyme catalyzed reactions. In determining enzyme properties, calorimetry can be a powerful technique, since virtually every known reaction, not driven by entropy, is causing some change in enthalpy and thus, nearly any enzyme with any substrate can be monitored. The more heat that is developed or absorbed per time unit, the higher the rate of this reaction is. When the enthalpy of a reaction per mole of substrate is known, the rate of this reaction can be determined by converting the change of heat to a change in reactant concentration over time.

When determining enzyme kinetics, calorimetry has several advantages in comparison to, for instance, spectrophotometric or fluorimetric assays. First, calorimetry is not limited to reactions causing a change in color or fluorescence, so no labelled substrates and no coupled (bio)chemical reactions are needed for detection. Furthermore, changes in heat can be measured continuously so the reactions do not have to be stopped after certain time points to determine the reaction progress. Enthalpy change is associated to almost every reaction, therefore, theoretically, nearly all enzymatic reactions can be measured using this technique, without restrictions in nature of the substrate or solvent complexity.

Recently, a new chip-based microfluidic calorimeter has been developed by Johannes Lerchner (Lerchner, J., A. Wolf, et al. “A new micro-fluid chip calorimeter for biochemical applications.” Thermochimica Acta (2006) 445(2): 144-150). This stopped-flow, microfluidic calorimeter can take up two samples and bring these together in a cuboid flow cell, where changes in temperature can be registered by four individual thermopiles. This reference is herein incorporated by reference.

The calorimeter described herein is based on such calorimeter. The calorimeter is herein also indicated as ChipCal. The calorimeter may herein also be indicated as “CC”. While modern power-compensating calorimeters use sample volumes of 0.2 to 2 ml, the ChipCal contains a measuring flow cell of only 18 μL. This smaller flow cell significantly decreases the sample size needed and the measuring time required, which paves the way for high-throughput microfluidic calorimetric measurements. In comparison with modern calorimeters, which may need up to thirty minutes between measurements, the ChipCal only needs approximately five minutes, or even less, for cleaning and experiment initialization between each experiment.

Further, the ChipCal may not necessarily make use of power compensation. This means that changes in temperature of the flow cell are not actively compensated by heaters. In embodiments, heat sinks, connected to the cell, ensure a heat flow to or from the thermopiles. For instance, in embodiments the heat flow is established by keeping the temperature around the cell constant.

A schematic overview of an embodiment of the calorimeter herein proposed and used can be found in FIG. 1. The (four) thermopiles, connected to the heat sinks (indicated as four rectangles), measure heat changes by utilizing the thermoelectric effect, also called Seebeck effect. When a temperature gradient is applied over these thermopiles, for instance due to a biochemical reaction inside the cell, a difference in the energy of the electrons on both sides of the thermopiles will create an electron motive force within the material, which is measurable as a potential. This voltage, in microvolts (μV), is linearly proportional to the temperature difference inside and outside the cell. Then, if the enthalpy of the reaction (ΔH, in kJ/mol) is known, the rate of the reaction can be determined by using a calibration factor converting the signal from Volts to Joule per second. Furthermore, it is possible to determine the total amount of heat developed during the reaction by calculating the integral of the curves obtained from the instrument in microvolts times seconds (μV·s). Since the substrate end concentration in the flow cell as well as the flow cell volume can also be determined, the total voltage per mole of substrate can be calculated.

However, the acquired signal may not solely be influenced by the reaction heat and the properties of the thermopiles. Due to the small scale of the instrument, factors such as heat loss, diffusion and heat transfer, within and outside the cell, can all have significant impacts. In a microfluidic cell, without active mixing, all flows within the system are laminar. This makes the mixing of two flows within such a cell dependent on diffusion and convection. These factors contribute to the fact that the signal provided by the thermopiles, may be somehow corrected for incomplete mixing and diffusion rates.

A possible calibration method is the protonation of tris(hydroxymethyl)-aminomethane (TRIS) by hydrochloric acid (HCL). However, this method was deemed unsuitable because the reaction appeared to happen too fast and was already taking place during the initialization of the instrument. Because of different dead times between the four thermopiles, different proportions of the reaction were registered, making the thermopiles appear to react differently on changes in enthalpy.

Hence, it is an aspect of the invention to provide a (alternative) calibration method, accounting for the several factors influencing such microfluidic calorimeter, which preferably further at least partly obviates one or more of the above-described drawbacks.

Surprisingly, it was found that the ionization of ATP and phosphate as a consequence of a pH change were more suitable calibration methods. The signals provided by the thermopiles due to these reactions deviated less among each other. Moreover, these methods also provided more consistent data if the experiments were to be repeated. Hence, in the invention a deprotonation reaction is applied.

Hence, in a first aspect the invention provides a (new) calibration method for calibrating a chip-based microfluidic calorimeter (herein thus also indicated as “ChipCal device” or “ChipCal” or “calorimeter”), wherein the chip based microfluidic calorimeter comprises one or more thermopiles, especially a plurality of thermopiles, wherein the calibration method uses the deprotonating reaction of a phosphate group, the method comprising: providing calibration liquids comprising (i) a buffer with a pH range of at least 7-9 and (ii) a first compound with a group, especially a phosphate group, which is protonated in a pH range of at least 3-6, and mixing these calibration liquids in the chip-based microfluidic calorimeter to provide a calibration liquid mixture whereby heat is generated, measuring the heat by the thermopiles and thereby providing a corresponding thermopile signal, and calibrating the chip-based microfluidic calorimeter by relating the thermopile signal to reference data of the deprotonating reaction.

With such method, the ChipCal can be calibrated reliably. The output of the calorimeter, which may be in (micro) volts may now be calibrated to (micro) joules. The proposed reaction seems to be much better suited for the present application than the protonation of tris(hydroxymethyl)-aminomethane (TRIS) by hydrochloric acid (HCl). The TRIS-HCl reaction is relatively fast due to fast diffusion of protons and thus, its use as a calibration reaction does not accutes for diffusion. In contrast with the presently proposed reaction, effects of diffusion are considered. Hence, with the present invention the chip-based microfluidic calorimeter can be calibrated in the sense that the output signal ((micro) volts) of the chip is an energy signal, such as (micro) joule or in the sense that the output signal can be recalculated as energy signal, such as (micro) joule. For instance, the calorimeter may be functionally coupled to a computer, which provides as output data of the calorimeter the energy signal, such as (micro) joule.

Herein, the term “chip based microfluidic calorimeter” is used as the reactor herein used is implemented in a chip which includes small channels through which liquids may flow. Channel diameters have in general sub-micrometer to sub-millimeter dimensions. The chip may be made by photolithography with silicon as chip material. However, other methods and materials are also possible, such as e.g. glass, ceramics and metal etching, deposition and bonding, polydimethylsiloxane (PDMS) processing (e.g., soft lithography), thick-film- and stereo lithography, as well as fast replication methods via electroplating, injection molding and embossing, etc.

The calorimeter especially comprises at least two inlets, which may be used for introduction of the calibration liquids.

Further, the calorimeter may comprise a mixing chamber. In this chamber, the two or more calibration liquids may mix, whereby heat may be generated. These inlets are in fluid contact with such calibration chamber.

The calorimeter may further include one or more thermopiles. These may be in thermal contact, especially physical contact, with one or more walls of the mixing chamber. A thermopile is an electronic device that converts thermal energy into electrical energy. It may be composed of several thermocouples connected usually in series (or in parallel). Thermopiles do not respond to absolute temperature, but may generate an output voltage proportional to a local temperature difference or temperature gradient. In embodiments, such as described in US2016047700, a thermopile comprises a number of thermocouples in series, to measure the temperature difference. In a thermopile, an equal number of thermocouple junctions may be installed on each of the sample and reference systems. The junctions may be connected in series with alternate junctions on the sample and reference systems. For example, the positive lead of a sample junction connects to the positive lead of a reference junction and the negative lead of the sample junction connects to the negative lead of another reference junction. The junctions are connected in series in this manner until all junctions are connected and there is one free lead wire connected to a reference junction and one free lead wire connected to a sample junction. The free sample and reference lead wires will both be either positive or negative. The differential temperature between the sample and reference systems can be determined from the voltage across these wires. In the case of a thermopile sensor, the sensitivity of the sensor is equal to the product of the number of thermocouple junctions on the sample or reference side, the Seebeck coefficient of the thermocouple pair and the thermal resistance of the sensor. Thus, higher output sensors can be made by using a thermopile to measure the temperature difference. A plurality of thermopiles may be in thermal contact with the mixing chamber. For instance, over a certain length of the mixing chamber, the thermopiles may be in thermal contact with the mixing chamber (wall). Note that the thermopiles may not be in direct contact with the liquid in the mixing chamber. Hence, in embodiments the chip based microfluidic calorimeter comprises a mixing chamber, wherein the mixing chamber has a mixing chamber length (L), and wherein the one or more thermopiles are configured to measure at different positions distributed over the mixing chamber length (L). In general, at least two, such as 2-10, like 2-6 thermopiles may be applied.

Herein, the term “mixing chamber” is applied to indicate a chamber where the calibration liquids are mixed. Note that the calorimeter (after calibration) may also be used for reactions. Hence, instead of the term “mixing chamber” also the term “chamber” or “reaction chamber” may be applied as well. Especially, the mixing chamber has a volume selected from the range of 1-1000 μl, such as 5-200 μl, like 10-100 μl.

In embodiments, after filling the mixing chamber with a volume equal to the volume of the mixing chamber with the calibration liquid mixture, flows of the calibration liquids to the mixing chamber is terminated and said heat is measured by said thermopiles. Hence, a “stop-flow” (or “stopped-flow”) (calibration) method may be applied. The measurement may take place only about 0.5-60 seconds, such as 2-20 seconds. The mixing chamber may be filled with the calibration liquids to provide the calibration liquid mixture in the mixing chamber. Especially, the mixing chamber is filled with the calibration liquids/calibration liquid mixture for at least 90%, especially completely filled. The term “equal” may also refer to “substantially equal” as known to a person skilled in the art.

The calibration liquids may be introduced into the calorimeter with means known in the art. One or more elements to flow the calibration liquids, such as a pump, etc., may be configured external from the calorimeter. However, in embodiments the calorimeter may also include a pump integrated in the calorimeter chip.

The mixing of the calibration liquids may follow by introduction of the liquids into the mixing chamber. Mixing may however be facilitated by integrating passive mixing elements in the calorimeter (chip). Hence, in embodiments the microfluidic calorimeter further comprises a mixing element, especially wherein the mixing element comprises one or more of a multi-lamination micromixer, a chaotic mixer, and a split-and-recombine mixer. Such passive mixing elements are known in microfluidic technology.

Before the calibration liquids are introduced, it may be desirable to thermally equilibrate the calibration liquids. To this end, the calibration liquids (not yet mixed) may be introduced in microfluidic channels and/or chambers upstream of the mixing chamber which microfluidic channels and/or chambers are comprised by a heat sink and/or which may be in thermal contact with a device configured for heating and/or cooling the microfluidic channels and/or chambers, or even substantially the entire calorimeter. Hence, in embodiments the method further comprises thermally equilibrating the calibration liquids prior to providing said calibration liquid mixture.

The terms “upstream” and “downstream” relate to an arrangement of items or features relative to the propagation of a liquid from a liquid providing means (e.g. a pump), wherein relative to a first position within a flow from the a liquid providing means, a second position in the flow closer to the a liquid providing means (than the first position) is “upstream” (relative to such first position), and a third position within the flow further away from the a liquid providing means (than the first position) is “downstream” (relative to the first position).

Further, the mixing chamber may be configured in liquid contact with an outlet, for removal of mixed liquid. As indicated above, the mixing chamber may have a length. Hence, at one side the mixing chamber may be in fluid contact with the inlets and at the other side of the mixing chamber, the mixing chamber may be in fluid contact with an outlet. Hence, the calorimeter may also comprise an outlet (different from the inlets for the calibration liquids).

As indicated above, the calibration method uses a deprotonating reaction for calibration, especially a deprotonation reaction of a (protonated) phosphate group. To this end, one of the calibration liquids comprises a protonated species (i.e. a species that can act as an acid), especially a protonated phosphate group. Especially, the protonated species is a (weak) acid, such as H₂PO₄⁻, or at least partially protonated ATP. Hence, in embodiments the phosphate group comprises phosphate (PO₄³⁻). For instance, H₂PO₄⁻ also comprises such group, but protonated (with two protons). In specific embodiments, the first compound comprises ATP. In embodiments, the first compound comprises a R₁P(O)R₂R₃ group, wherein R₁, R₂ and R₃ are each independently selected from the group consisting of H, OH, and a hydrocarbon (including an alkoxy and/or aryloxy), wherein at least one of R₁, R₂ and R₃ comprise OH. Hence, in embodiments the first compound especially comprises an —P(O)(OH)— group, wherein “—” indicate a bonding to another element; for instance, ATP comprises three —P(O)(OH)— groups. The phosphate group may also comprise an inorganic phosphate group (that can be protonated or deprotonated). Note that the first compound may have more than one pH, such as in the case of PO₄³⁻, with H₃PO₄, H₂PO₄⁻, and HPO₄²⁻. The protonated species is especially chosen to be in a buffer with a pH lower than the pH of the other calibration liquid (which calibration liquid especially comprises a buffer), or in a buffer with a pH lower than the pKₐ of the protonated species.

Further, one of the other calibration liquids comprises a liquid at a pH where the protonated species, when in contact with other calibration liquid will at least partly deprotonate. Especially, such further liquid is a buffer, having buffer capacity at a pH larger than the pH of the first compound. Especially, the difference between the pH and the buffer range is at least about 0.5, such as at least about 1. For instance, the pH of the protonated species may be about 5 and buffer may have a buffer range of 6-8. For instance, a 1 molar ATP solution may have a pH of 6.5. As buffer, buffers known in the art may be applied. Good results were obtained with MOPS. Hence, in embodiments the buffer comprises 3-(N-morpholino)propanesulfonic acid (MOPS), which is a good buffer at (about) pH=7.

In specific embodiments, the calibration liquids comprise (i) a buffer with a pH range of at least 7-9 and (ii) a first compound with a group, especially a phosphate group (or other group), which is protonated in a pH range of at least 3-6, respectively. These calibration liquids may be introduced into the calorimeter, and after optional thermal equilibration, be introduced into the mixing chamber. Hence, the method may further include mixing these calibration liquids in the chip-based microfluidic calorimeter to provide a calibration liquid mixture. Hereby, heat is generated, measured by the thermopile(s) and thereby a corresponding thermopile signal is provided. Hence, the reaction chosen for calibration of the calorimeter is an exothermic mixing reaction. Note that the term “thermopile signal” may also refer to a plurality of thermopile signals such as when measuring over time and/or due to the fact that more than one thermopile may be applied.

Hence, especially the first compound has a pKₐ smaller, such as at least 0.5 smaller, than the pH range of the buffer. Especially the phrase “protonated in a pH range of at least 3-6” and similar phrases especially imply that the first compound has a pKa in such range and that the concentration(s) (of the first compound and optionally a strong acid and/or a buffer) are chosen such that the pH of the liquid comprising the first compound is also in this range.

Hence, in embodiments, the calibration liquids comprise (i) a first liquid comprising a buffer with a first pH buffer range and (ii) a second liquid comprising a first compound with a group, which has a pKa smaller, especially at least 0.5 smaller than the first pH buffer range, and with the second liquid having a pH at least 0.5 smaller than the first pH buffer range.

As the amounts of liquids introduced, the flow of the liquids, the concentration, etc. are known, one may calculate the reaction heat generated and use this to calibrate the calorimeter. Hence, in embodiments the reference data comprise kinetic reference data.

Additionally or alternatively, reference data from other calorimetric measurements (of the same reaction) may be used. Therefore, in specific embodiments the reference data of the deprotonating reaction are based on isothermal titration calorimetry. Especially, the method may further comprise executing a further calibration method with the calibration liquids, wherein the further calibration method comprises isothermal titration calorimetry, for generating said reference data. Hence, the reference data may be available before the method or may be generated during the method.

Hence, the method further includes calibrating the chip-based microfluidic calorimeter by relating the thermopile signal to reference data of the deprotonating reaction. Further, for calibration a plurality of measurements may be applied. This may refer to performing control measurements. However, this may especially also imply applying measurements at different concentrations such that over a wider range the calorimeter may be calibrated. Hence, in further embodiments the method comprises sequentially providing a series of calibration liquids having different concentrations of the first compound to the microfluidic calorimeter, measuring the heat by the thermopiles thereby providing corresponding thermopile signals, and calibrating the chip-based microfluidic calorimeter by relating the thermopile signals to reference data of the deprotonating reaction.

Hence, in yet a further aspect the invention also provides a chip-based microfluidic calorimeter (“calorimeter”) calibrated according to the method as defined herein. Such (calibrated) chip based microfluidic calorimeter may e.g. be used for measuring an enzymatic activity, such as to determine the rate of reaction or to screen for a specific activity.

The invention also provides a kit for calibration of the calorimeter as described herein. Hence, the invention provides in embodiments a calibration kit comprising a set calibration liquids comprising (i) a buffer, with especially a pH range of at least 7-9 (one of the calibration liquids), and (ii) an acid, which especially is protonated at a pH lower than the buffer pH range, especially a liquid comprising a first compound with a phosphate group which is protonated in a pH range of at least 3-6. Further, the kit may optionally include a manual for calibrating a chip-based microfluidic calorimeter with the set of calibration liquids. In further embodiments, the calibration kit comprises a first container comprising a first calibration liquid comprising said buffer, and comprising a plurality of second containers comprising said first compound, wherein each second container comprises a second calibration liquid with mutually different concentrations of said first compound.

Especially, the buffer comprises 3-(N-morpholino)propanesulfonic acid (MOPS) and the first compound comprises ATP.

In yet further embodiments, the kit further includes the calorimeter (to be calibrated).

In general, all liquids described herein are aqueous liquids.

The microfluidic chip may, after calibration, also be used for measuring, such as measuring enzymatic activity. Herein, the chip is especially described in relation to the calibration (method). However, the chip may thus also be described in relation to other methods that may be executed with the chip, wherein especially the thermopiles are used for measuring heat. Hence, in embodiments instead of the term “calibration liquid” also the term “liquid” or “reaction liquid” may be applied as well.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1a: Schematic overview of the ChipCal. Samples are loaded via a first inlet and a second inlet and simultaneously pumped through the microfluidic system: tubing, the heat exchanger and finally into the flow cell were the flow is stopped and changes in heat are registered by the four thermopiles; FIG. 1b schematically depicts a perspective view of an embodiment of the reaction chamber and thermopiles;

FIG. 2 schematically depicts some possible stages of the calibration method;

FIG. 3 schematically depicts a calibration kit;

FIGS. 4a-d show some data from calibration measurements;

FIGS. 5a-5d depict some measurements of the enthalpy of an enzymatic reaction.

The schematic drawings are not necessarily on scale.

### DETAILED DESCRIPTION OF THE EMBODIMENTS

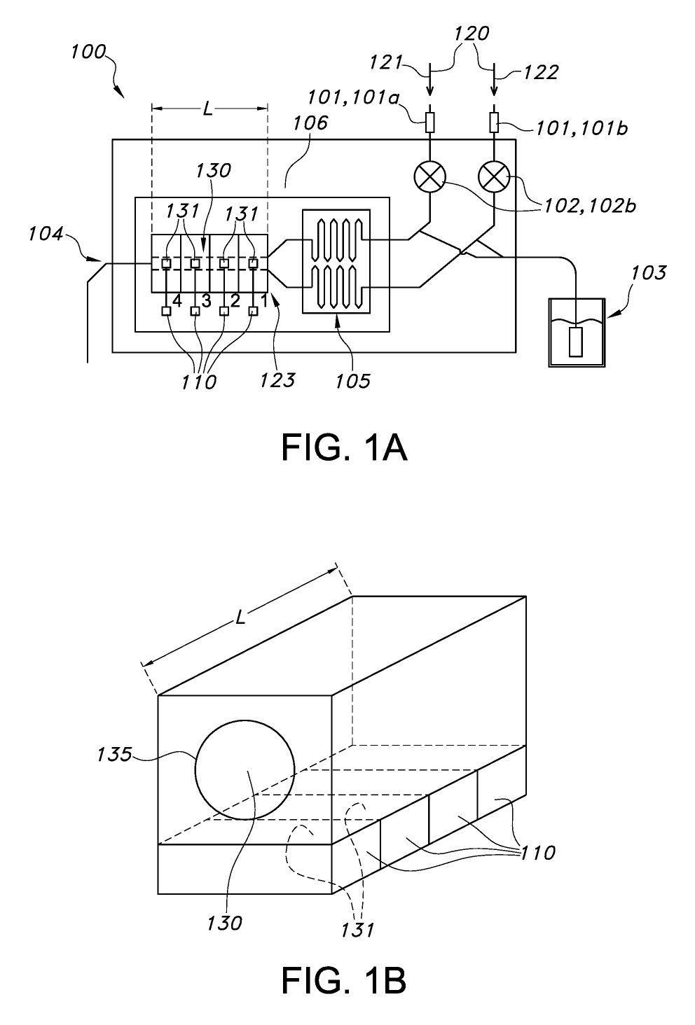

As indicated above, FIG. 1a schematically depicts an embodiment of the chip-based microfluidic calorimeter 100. Calibration liquids 120 are loaded via inlets 101. Here, two different calibration liquids 121 and 121 are applied, and introduced via a first inlet 101a and a second inlet 101b, respectively. One may e.g. include the buffer and the other may include the acid as defined above. The calibration liquids 120 are simultaneously pumped through the tubing (microfluidics), and an optional heat exchanger for thermally equilibrating the calibration liquids. The calibration liquids 120 are flowed into the mixing chamber (or reaction chamber), indicated with reference 130. Hereby, a calibration liquid mixture 123 is formed. The mixing chamber is indicated with dashed lines. When the mixing chamber 130 is filled the flow of the calibration liquids 120 may be stopped and changes in heat are registered by the (four) thermopiles indicated with reference 110. In an example, the volume of the mixing chamber or reaction chamber 130 is about 18 μL.

In this embodiment, the mixing chamber 130 has a mixing chamber length L. The one or more thermopiles 110 are configured to measure (heat changes in the mixing chamber) at different positions 131 distributed over the mixing chamber length L. The thermopiles may not be in liquid contact with the calibration liquid mixture 123.

Reference 103 refers to a system fluid, which may be in liquid contact with the microfluidic system, which is indicated with reference 106. The system fluid may be used for flowing the cell. It can be used to inject the substrate and enzyme via the syringes into the cell. In embodiments, there might be an air gap between the system flow and the two components that are injected via the syringes. Here, by way of example the chip-based microfluidic calorimeter 100 also includes pumps 102, indicated with references 102a and 102b for the different channels for the different liquids, here the calibration liquids 121,122, respectively. Reference 104 indicates an outlet of the chip-based microfluidic calorimeter 100, such as to a waste reservoir. The rectangle may indicate a heat shield, substantially enclosing at least the mixing chamber and at least part of the thermopile(s) (at least the sensor part). Optionally, the heat shield may also enclose a thermal equilibration region 105, such as a heat exchanger. However, such a thermal equilibration region 105 may also be configured external of the heat shield. Further, the thermal equilibration region may include a heat exchanger and/or a heat sink, enclosing at least part of the micro-fluidic system 106.

For instance, in embodiments analogues to the device described by Lerchner et al. (see above), to ensure high signal resolution a calorimetric module is mounted inside a high-precision thermostat or heat shield which has a temperature stability of better than 100 μK. The developed two-stage thermostat consists of two nested U-shaped frames. At the outer sides of the walls foil heaters are attached. To enable fast response the control temperature sensors (thermistors 10 kΩ, BetaTherm) are placed inside the walls near the centre of the foil heaters. For temperature control two independent digital PID controllers with optimized parameters are used. The control temperatures for the outer and inner frame may be set to 25 and 25.3° C., respectively. A thermistor temperature sensor is placed inside the copper heat sink of the calorimetric module. The temperature is measured with a resolution of 6K and can be utilized for the correction of external temperature perturbations which are not completely suppressed by the thermostat. The inlets of the PMMA reaction chamber are connected with miniaturized piston pumps via Teflon tubes. The piston pumps (LEE LPV50) are part of fluid units and are operated together with sets of micro-valves (LEE LFVA) for reactant selection. Typical volume flow rates are ranged from 5 to 30 μl/min. Volume flow rates higher than 50 μl/min may exceed the capacity of the fluid heat exchanger. For the temperature equilibration of the liquids micro-machined heat exchangers (IPHT Jena) are used whose dead volumes are 15 l in each case. At first the liquid flows pass heat exchangers attached at the inner frame of the thermostat. A final temperature equilibration is achieved by heat exchangers attached at the bottom side of the copper heat sink plate. If volume increments of less than 15 μl are injected optimal thermal adaptation of the reactants is assured. Further, the calorimetric system is equipped with an electronic unit for data acquisition, automatically operation of the fluid units and performing of the temperature control. The user interface is realized by a PC which is connected to the electronic unit.

FIG. 1b schematically depicts a perspective view of the mixing chamber 130, here by way of example a tubular mixing chamber. However, the mixing chamber may also have a square or rectangular cross-section. The mixing chamber is defined by a mixing chamber wall (and one or more inlets and an outlet). The mixing chamber wall may e.g. be made from Poly(methyl methacrylate) (PMMA), Polydimethylsiloxane (PDMS), etc., or other suitable polymers for micrcofluidic devices. At different positions 131 along the mixing chamber 130 thermopiles 110 are configured for measuring the heat generated within the mixing chamber 130.

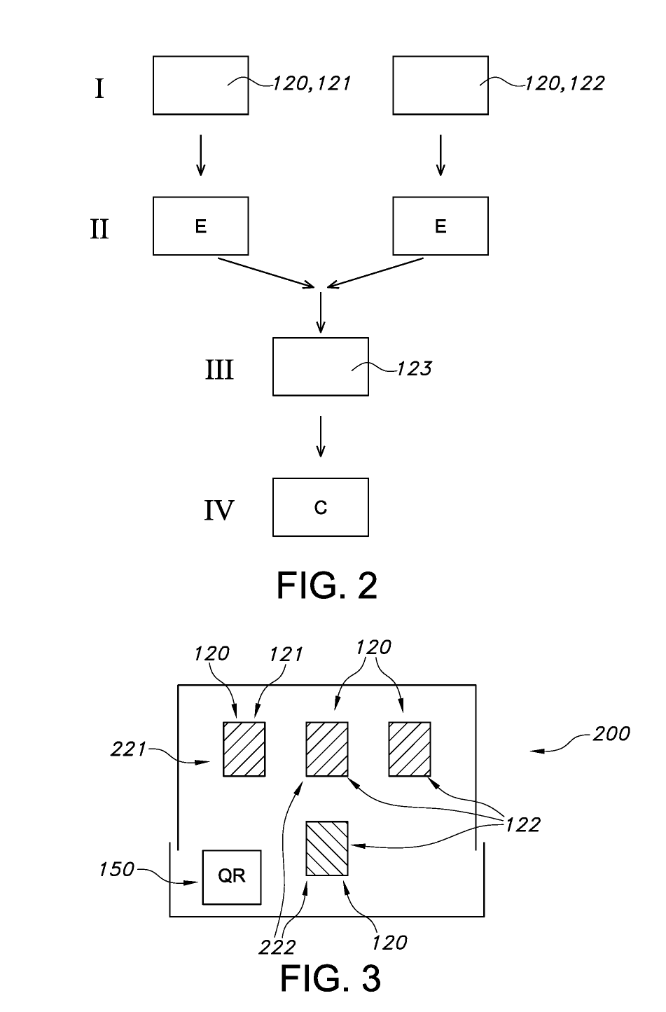

FIG. 2 schematically depicts some possible stages of the calibration method, including a first stage I of providing the calibration liquids 120, an optional equilibration stage II, a mixing and measuring stage III wherein the mixing of the calibration liquids 121,122 provide the calibration liquid mixture 123 (and heat) and wherein the generated heat can be measured. This stage is followed by a calibration stage IV. Then, the calorimeter can be used for other measurements.

FIG. 3 schematically depicts an embodiment of a 15 calibration kit 200 comprising a set calibration liquids 120 comprising a buffer with a pH range of at least 7-9 (calibration liquid 121), and another calibration liquid 122, comprising a first compound which loses a proton at this pH, such as a phosphate group which is protonated in a pH range of at least 3-6. Optionally, the kit may further include manual 150 for calibrating a chip based micro-fluidic calorimeter 100 with the set of calibration liquids 120. Here, the kit especially includes a plurality of second containers 222 comprising said first compound, wherein each second container comprises a second calibration liquid 122 with mutually different concentrations of said first compound. Reference 221 refers to a first container, containing the first calibration liquid comprising the buffer. The term “manual” may refer to written information on one of these container, or a separte sheet, folder, booklet, or book, etc., with written information. However, the term “manual” may also refer to a manual on the internet. Hence, also a QR code, or other code, facilitate a user to go to an internet page with such manual is herein considered a manual.

### EXAMPLES

All experiments were performed at 37° C. unless noted otherwise. The experiments were not performed at room temperature since this can change between days and between points of time in a day, and enthalpy changes can be influenced by environment temperature. It was specifically chosen to work at 37° Celsius since the enzymes used for this research performed better at this temperature.

MOPS, p-nitrophenyl phosphate, HCl and ATP were obtained from Sigma-Aldrich. KCl, and TRIS were obtained from Merck. NaCl, NaOH, KH₂PO₄ and MgCl₂ were obtained from J. T. Baker. A second batch of ATP was acquired from Roche.

Alkaline phosphatase from Bovine intestinal mucosa was used, which was obtained from Sigma-Aldrich. The pH of the solutions was adjusted by using HCl or NaOH solutions in Milli-Q water.

The ChipCal instrument and software were provided by TTP LabTech. The samples were filtered and degassed prior to the experiments, to prevent clogging and the forming of extra air bubbles respectively. Enzymatic solutions, or other solutions also named samples, can e.g. be injected via a pen in the first inlet 101a pen into inlet 101a (FIG. 1). Substrate solutions, or other solutions, can e.g. be injected via a pen into second inlet 101b (FIG. 1). Between each experiment, a quick wash program was run to clean the flowcell with the system fluid. At the end of a set of experiments, a full wash program was performed with detergent (provided by TTP LabTech) and subsequently a clean water program was performed with Milli-Q water.

When a reaction occurs in the cell of the ChipCal, the thermopiles register a signal, taking five measuring points per second. However, there are also other phenomena that contribute to the signal, i.e. friction heat because of laminar flow and heat of dilution. These contributions can be independently measured by performing several blanks. The true signal, caused by the reaction, can be acquired by correcting for these blanks. First, when injecting two identical solutions in the flowcell, a change in temperature is observed by the thermopiles due to the physical forces of the two flows colliding and flowing through the cell. To determine this factor, one performs the experiment using the system fluid as both samples. Secondly, when a sample in solution is injected into the flowcell, the dilution of this compound into the other sample is also measurable as a change in temperature, the enthalpy of solution. To correct for this phenomenon, the dilution enthalpies for both samples may have to be determined. To determine this factor, one may perform the experiment of injecting one of the samples in one inlet and a sample solely containing the system fluid, the solvent, in the other inlet. By subtracting the friction blank from this signal acquired from this experiment, the change in heat registered by the thermopiles, caused by the dilution can be obtained. To determine the signal caused by the reaction, one may have to subtract the two dilutions blanks from the total signal. Since the enthalpy change caused by physical forces also occur in both of these two blanks, this factor is in fact subtracted twice. Therefore, one finally may have to add the physical blank once to the equation to determine the registered enthalpy caused by the reaction. This procedure is summarised in the equation shown below:

ΔH_{reaction}=ΔHₜₒₜₐₗ−ΔH_{dilution sample A}−ΔH_{dilution sample B}+ΔH_{friction}

For isothermal titration calorimetry (ITC), the Microcal VP-ITC from Malvern was used. The machine was set on high feedback mode with a reference power of 15 μCal/s. The stirrer rotated at 502 rpm. The filtering time of the machine was set on 2 seconds. To check reproducibility, two measurement injections were performed per run, preceded by a 2 μL injection to get rid of a possible headspace of air in the syringe that occurs during the initial filling of the syringe. For each measurement, 3 μL of substrate was injected from the syringe to the cell in three seconds. Adequate measuring time was used to allow the reactions to be completed and for the signal to return to the baseline. Samples were degassed and heated up to experimental temperature prior to all experiments. The same solvent was used to dissolve all compounds used for a set of experiments. As a blank, the enthalpy of solution for the sample in the syringe was determined by injecting 3 μL of the sample in the cell, containing solely the diluent. All experiments were performed in triplicate.

### TRIS-HCl Calibration

### ChipCal

20 mM, 15 mM, 10 mM or 5 mM solutions of hydrochloric acid (HCl) in Milli-Q water were mixed with a 200 mM tris(hydroxymethyl)aminomethane (TRIS) solution in Milli-Q water, pH 10.6 in the flowcell. In the ChipCal, the TRIS solution was injected via a pen in the first inlet 101a, the HCl was injected via a pen in the second inlet 101b. Milli-Q water was used as the system fluid. For the blank, a 200 mM TRIS solution in Milli-Q water was injected via needle A and Milli-Q water was injected via needle B. All blanks and experiments were performed in triplicate. Finally, these experiments were repeated on different days, up to a total of three times. The solutions were prepared fresh each day to analyse the reproducibility.

### ITC

200 mM TRIS in Milli-Q water, pH 10.6, was injected in the measuring cell of the VP-ICT. The syringe was filled with a 1 mM HCl in Milli-Q water solution. The experiments were performed in triplicate.

### ATP-MOPS Calibration

### ChipCal

20 mM, 15 mM, 10 mM or 5 mM solutions of adenosine triphosphate, disodium salt (ATP), in a 200 mM MOPS, 20 mM Sodium Chloride (NaCl) solution at pH 5.0 in Milli-Q water were prepared. Lower reactant concentrations were chosen to reduce the effect of the ATP on the pH of the buffer. This was done since MOPS has low buffering capacity at pH 5.0. The ATP solutions were injected via a pen in the first inlet 101a. Via a pen in the second inlet 101b, a 200 mM MOPS, 20 mM NaCl solution at pH 8.0 was injected. The MOPS buffer at pH 5.0 was used as the system fluid. To obtain the heat due to physical friction, the MOPS solution at pH 5.0 was injected in both pens. For the dilution of ATP, the ATP solutions were each injected with the MOPS buffer at pH 5.0. To correct for the different ionisation states of the MOPS buffer, MOPS at pH 5.0 was injected together with MOPS pH 8.0. To check the consistency of the calibration with ATP, a batch from a different producer, here called ATPo, was acquired and these experiments were repeated. To investigate the influence of temperature on the instrument and the reactions, the temperature outside the cell was set on 28° C. and the experiments were repeated for the original batch of ATP, from now called ATPx. All blanks and experiments were performed in triplicate. The experiments with the first batch of ATP at 37° C. were repeated up to three times on different days with freshly made solutions to check reproducibility. The experiments with ATPo were performed on the same day, with the same buffers as one set of the ATPx experiments to ensure comparability.

### ITC

A 200 mM MOPS, 20 mM NaCl buffer at the pH of 7.0 was injected into the cell. The pH of 7.0 is the end pH when mixing the MOPS buffer at pH 5.0 and pH 8.0 one to one. The syringe was filled with 10 mM of ATP in a 200 mM MOPS, 20 mM NaCl buffer at pH 5.0. This was done for both batches of ATP. The experiments were performed in triplicate. To determine the influence of temperature, the instrument temperature was set at 28° C. and the experiments with ATPx were repeated.

### PO4-MOPS Calibration

### ChipCal

20 mM, 15 mM, 10 mM or 5 mM solutions of KH₂PO₄ in a 200 mM MOPS, 20 mM NaCl solution at pH 5.0 in Milli-Q water were prepared on different days to check reproducibility. The concentrations of phosphate were doubled after the first set to increase change in heat caused by the reaction. Since the enthalpy change is calculated to J/mol, the first set was still usable. Again, low reactant concentrations were chosen to reduce the impact on the pH of the buffers. The PO₄ solutions were injected via a pen in the first inlet 101a. Via a pen in the second inlet 101b, a 200 mM MOPS, 20 mM NaCl solution at pH 8.0 was injected. The MOPS buffer at pH 5.0 was used as the system fluid. To obtain the heat due to physical friction, the MOPS solution at pH 5.0 was injected in both pens. For the dilution of KH₂PO₄, the phosphate solutions were each injected with the MOPS buffer at pH 5.0. To correct for the different ionisation states of the MOPS buffer, MOPS at pH 5.0 was injected with MOPS pH 8.0. All blanks and experiments were performed in triplicate.

### ITC

A 200 mM MOPS, 20 mM NaCl buffer at the pH of 7.0 was injected into the cell. The pH of 7.0 is the end pH when mixing the MOPS buffer at pH 5.0 and pH 8.0 one to one. The syringe was filled with 10 mM of KH₂PO₄ in a 200 mM MOPS, 20 mM NaCl buffer at pH 5.0. The experiments were performed in triplicate.

### PO₄-TRIS Calibration

### ChipCal

40 mM, 30 mM, 20 mM or 10 mM solutions of KH₂PO₄ in a 200 mM TRIS, 20 mM NaCl solution at pH 5.0 in Milli-Q water were prepared on different days to check reproducibility. The PO₄ solutions were injected via a pen in the first inlet 101a. Via a pen in the second inlet 101b, a 200 mM TRIS, 20 mM NaCl solution at pH 9.0 was injected. The TRIS buffer at pH 5.0 was used as the system fluid. To obtain the heat due to physical friction, the TRIS solution at pH 5.0 was injected in both pens. For the dilution of KH₂PO₄, the phosphate solutions were each injected in inlet 101a while TRIS buffer at pH 5 was injected in inlet 101b. To correct for the different ionisation states of the TRIS buffer, TRIS at pH 5.0 was injected together with TRIS pH 9.0. All blanks and experiments were performed in triplicate. Also, these experiments repeated up to three times on different days with freshly made solutions to check reproducibility. Since the 200 mM TRIS solution has a significantly low buffer capacity at pH 5.0, experimental errors can more easily be made while preparing the buffers at this pH. Therefore, to test the robustness of this method, the experiments were repeated for 20 mM KH₂PO₄ solution in TRIS at pH 4.5, 5.0 and 5.5. The method was repeated with these three samples, in triplicate.

### ITC

A 200 mM TRIS, 20 mM NaCl buffer at the pH of 7.5 was injected into the cell. The pH of 7.5 is the end pH when mixing the TRIS buffer at pH 5.0 and pH 9.0 one to one. The syringe was filled with 10 mM of KH₂PO₄ in a 200 mM TRIS, 20 mM NaCl buffer at pH 5.0. The experiments were performed in triplicates.

### Validation of the ATP Reaction: ³¹P-NMR

To validate the products of the reaction with ATP, Phosphorus-31 NMR experiments were performed with an Agilent 400-MR NMR. ATP solutions in 200 mM MOPS, 20 mM NaCl pH 5.0 or pH 7.0 were diluted in 10% D₂O and placed in 5 mm diameter NMR sample tubes. The instrument was calibrated with 85% H₃PO₄ as an external standard. The experiments were performed at room temperature and the instrument was operating at 161.98 MHz. The relaxation delay was 1.0 second, the acquisition time 0.8 seconds and the spectral width 249 ppm.

The ATP reaction was also validated with LC-MS.

### Diffusion Dependance

To evaluate the impact of diffusion, several different salts were dissolved in Milli-Q water. These samples were injected in pen A while Milli-Q water was injected in pen B to investigate the signals for dilution. For the friction blank, Milli-Q water was injected in both pens. Solely the shape of the curves was studied for these experiments. Therefore the experiments were only needed to be performed in duplicates to check reproducibility. The dilution experiments were compared with the curves of the TRIS-HCl reactions. Since the protonation of TRIS is a reaction that can be considered as happening immediate, this reaction is considered to be dependent on the diffusion of the protons. The concentrations of the different compounds were chosen based on the maximum extension of the signal caused by the heat of dilution. It was attempted to acquire signals with similar extensions. For optimal comparison, the maximal signal amplitudes were normalized to 100%. The compounds and concentrations used for this experiment can be found in table 1.

TABLE 1
The compounds used for the diffusion experiment
and the concentration used in mole per litre.

| Compound | Concentration (M) |
|---|---|
| HCl | 0.005 |
| KCl | 1.00 |
| NaCl | 1.00 |
| KH₂PO₄ | 1.00 |

To test the concentration dependence of the diffusion pattern, two more dilution experiments were performed with K H₂PO₄. For these experiments, the friction blank corrected signals for the dilution of 0.25 M and 1.0 M of K H₂PO₄ in Milli-Q water were again normalized and thereafter compared.

### Enzyme Activity Measurements

Alkaline Phosphatase (AP) from bovine intestinal mucosa was used to convert para-nitrophenyl phosphate (PNPP) into para-nitrophenol (PNP) and phosphate. For inhibition studies, KH₂PO₄ was added to the reaction mixtures, up to an end concentration of 2 mM. All compounds were dissolved in a 200 mM TRIS, 20 mM NaCl buffer at pH 8.5. The pH optimum for AP is at pH 10, however, due to the fact that the ChipCal might be damaged by high pH, it was chosen to work at a more neutral pH.

First, the properties of alkaline phosphatase were obtained by determining the Michaelis Menten curve from activity measurements using UV visible spectrophotometry. The conversion of several concentrations of PNPP, between 5 and 400 by 0.0667 nM of AP in TRIS buffer at pH 8.8, was observed by UV-vis at wavelengths of 405 and 420 nm at 37° C. By monitoring the initial increase in absorption and using a calibration curve for PNP, the initial rates at different substrate concentrations were obtained. At 405 nm a molar extinction coefficient of 14,500 M⁻¹ cm⁻¹ was found.

In order to make the comparison between UV-vis and the ChipCal, the conversion of PNPP by alkaline phosphatase was recorded at various wavelengths. However, only the wavelengths of 475 nm, 477 nm and 480 nm were used to determine the PNP concentration over time. As stated before, the maximum absorbance of PNP lies at 405 nm, but at this wavelength, the instrument reaches its limitations too quickly. Therefore, wavelengths at the shoulder of the absorbance curves were used to determine the product formation. Glass cuvettes with a light path length of 1 cm were used. The solutions were stirred continuously by using a magnetic stirrer to ensure a homogeneous solution. AP was added at an end concentration of 10 nM to a solution of 5 mM PNPP, with or without 2 mM of PO₄.

In the ChipCal, a 20 nM AP solution was injected by pen A and a 10 mM PNPP solution, with or without 4 mM PO₄, was injected via needle B. Extra washing programs were performed between the experiments to ensure removal of any remaining enzyme.

To compare the rates of the enzyme over time measured by the two instruments, the rate of the enzyme was determined by converting the signals at specific times points. For converting the signals obtained from the ChipCal, in the aim to reduce the influence of the noise, the average of ten measured points around a time point were taken to get to a mean signal. These ten points span two seconds of measurements and should not be influenced by a significant change in rate of the enzyme. For the UV vis experiments, the slope of the obtained signal was determined at the set time points to determine the rate. These slopes were acquired by taking the derivative of twenty signal points around the set time points. These twenty points span twenty seconds of measurement and should not be influenced by a significant change in rate of the enzyme.

To obtain enthalpies (AH) of reactions the reactions were reproduced in a 1.4 ml isothermal titration calorimeter, the Microcal VP-ITC from Malvern. Using this instrument, the conditions present in the ChipCal flowcell were applied to obtain relevant reactions enthalpies per mole of substrate. The enthalpy values acquired by the ITC were then used to determine the properties of the thermopiles and the instrument. By using sufficient time for the reactions occurring to complete the integrals of the signals gained from the ChipCal and ITC, in μV·s per mole and in Joule per mole respectively, can be determined. By combining the values of these integrals, the thermopile sensitivity in Volts times seconds per Joule (V·s/J), also noted as Volts per Watt (V/W), can be acquired.

The ChipCal is able to take up two samples of each 18 μL with two injection pens. The samples are guided through the tubing of the instrument by the system fluid. To prevent diffusion of the samples into the system fluid, the samples are flanked by two air bubbles of 3 μL (air gaps). The compounds for the samples should all be dissolved in the same diluent to decrease the background signal caused by the heat of dilution. For this reason, the system fluid, which is also used to flush through the tubing and the flow cell after an experiment, should be this solvent as well. This is necessary to decrease the dilution effects within the flow cell due to system fluid that may stick to the walls of the cell (Maskow, Schubert et al. 2011). Between experiments, the system can be programmed to flush the instrument using the software provided. The minimal diameter of the tubing within the system is as narrow as 0.4 mm and is thus susceptible to clogging. It is therefore advised to use water-soluble compounds and filter all samples prior to the experiments.

When the two samples of 18 μL are taken up by the needles, they are pumped through the system by two individual pumps at a flow rate of around 75 μL/minute. The samples are guided through a heat exchanger and finally brought together at the beginning of the measuring cell. The filling of this cell takes approximately 7 seconds. Thereafter, the flow is stopped and the heat measurement starts. The start is marked in the output by the instrument using a trigger.

The systems TRIS-HCl, MOPS-ATP and MOPS-KH₂PO₄⁻ were evaluated. The differences between the termopiles appears to be largest for the TRIS-HCL system. Comparing ATP and KH₂PO₄⁻, standard deviations for the ATP systems are smallest. Hence, for calibrating the calorimeter, ATP or KH₂PO₄⁻, may be suitable, with ATP providing the best results. Also a combination of TRIS and KH₂PO₄⁻, was tested but more reliable results are obtained with MOPS as buffer.

The calibration method is to calibrate chip-based microfluidic calorimeters. These type of calorimeters measure heat using thermopiles and the output of measurements is in micro volt, which should be covered to micro J/mol in order to be able to obtain rate of an enzymatic reaction. Hence, to do this, a calibration reaction with known enthalpy (micro J/mol) is required. The most widely used calibration method, which is based on the reaction of TRIS with HCl, is not suitable for chip-based microfluidic calorimeters because it does not account for diffusion. Herein, a new calibration method is proposed which is based on deprotonation of phosphate.

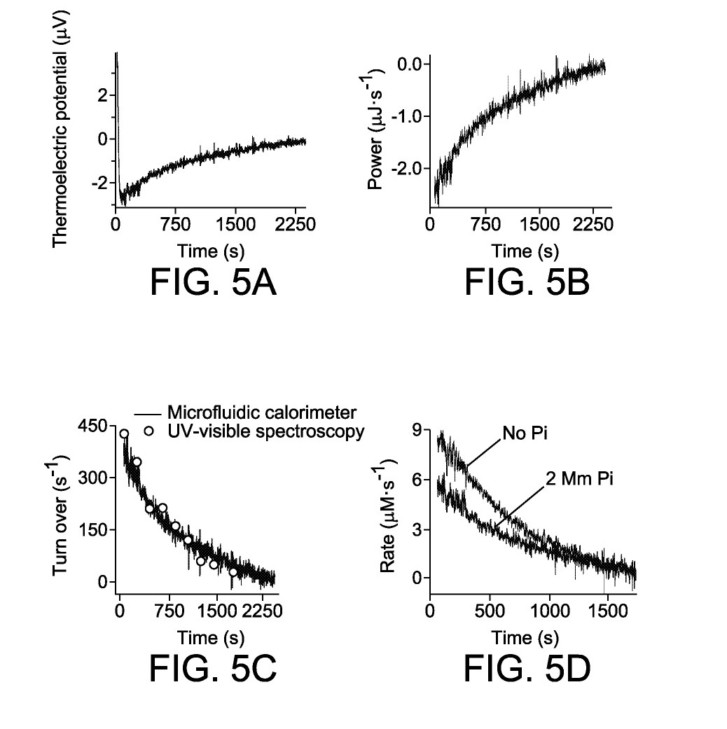

This method was applied to a chip-based microfluidic calorimeter for measuring enzymatic activity of alkaline phosphates. Using the new calibration method the activity measured by chip-based microfluidic calorimeter was similar to that obtained using UV-visible spectroscopy (FIG. 5).

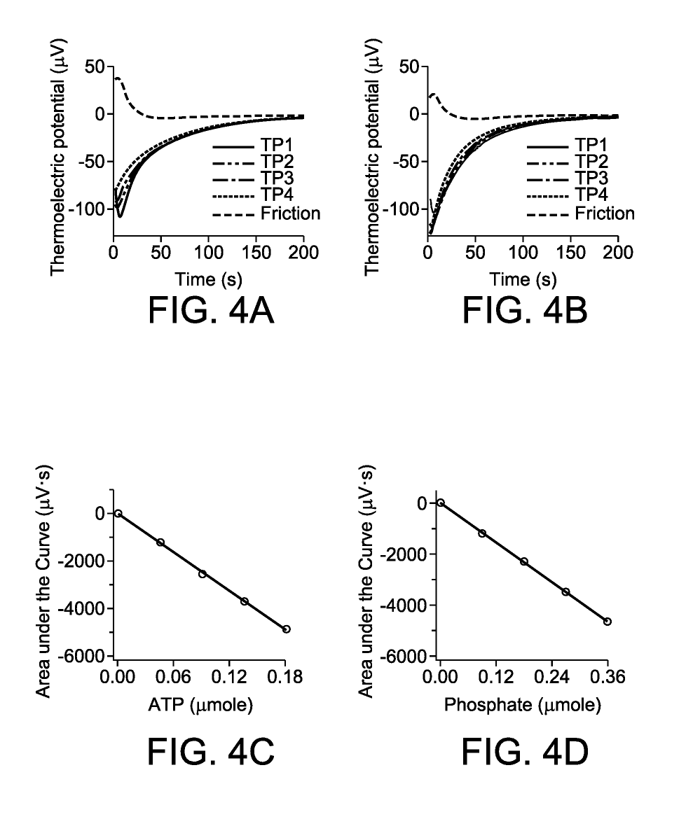

In an embodiment, the steps used for calibration method and some relevant figures are described below:
1. Preparing MOPS buffer pH 8.0
2. Preparing MOPS buffer pH 5, continuing different concentrations of phosphate or ATP, e.g. from 5 mM to 20 mM
3. Injecting the two buffers into the instrument. The two solutions will be mixed with a 1:1 ration in the microfluidic channel and the final pH will be around 7.0. As are result phosphate will be deprotonated and heat will be release, which will be recorded as a negative signal (micro volt) (FIGS. 4a and 4b).
4. Plotting the area under the curves recorded by the chip-based microfluidic calorimeter as a function of different concentrations of phosphate (FIGS. 4c and d), and obtaining the slope of a linear fit to the data (micro volt×s/mol) (FIGS. 4c and d).
6. Obtaining the enthalpy of deprotonation of phosphate in micro J/mol using a conventional calorimetric method such as isothermal titration calorimetry.
7. Calculating the sensitivity factor for thermopiles (volt/Watt) using the slope obtained in step 4 and the enthalpy of reaction.
8. The sensitivity factor for thermopiles can then be used to convert the data recorded for an enzymatic reaction to the rate of enzyme using the formula below:

Enzyme rate (mol/s)=Data recorded by calorimeter (micro volt)/[(sensitivity factor (volt/watt))×(enthalpy of enzymatic reaction (micro J/mol)).

FIGS. 5a-d shows the application of our method to obtain rate of an enzyme called alkaline phosphatase with PNPP as substrate. FIG. 5a is the raw data recorded by a chip-based microfluidic calorimeter. FIG. 5b, the the raw data in FIG. 5a are converted to micro J/s using our calibration method. FIG. 5c, the data in FIG. 5a are used to obtain the rate of enzymatic reaction (micro J/s), and the results (line) are compared to those obtained using UV-visible spectroscopy (dots). FIG. 5d, is using the calibrated calorimeter to measure inhibition of alkaline phosphatase activity, with the upper curve indicating enzymatic activity in the absence of phosphate as inhibitor and with the lower curve indicating enzymatic activity in the presence of phosphate as inhibitor.

The term “substantially” herein, such as in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A calibration method for calibrating a chip-based microfluidic calorimeter, wherein the chip-based microfluidic calorimeter comprises one or more thermopiles, wherein the calibration method uses the deprotonating reaction of a phosphate group, the method comprising: providing calibration liquids comprising (i) a buffer with a pH range of at least 7-9 and (ii) a first compound with a phosphate group which is protonated in a pH range of at least 3-6, and mixing these calibration liquids in the chip-based microfluidic calorimeter to provide a calibration liquid mixture whereby heat is generated, measuring the heat by the thermopiles and thereby providing a corresponding thermopile signal, and calibrating the chip-based microfluidic calorimeter by relating the thermopile signal to reference data of the deprotonating reaction.

2. The method according to claim 1, wherein the chip-based micro-fluidic calorimeter comprises a mixing chamber, wherein the mixing chamber has a mixing chamber length, and wherein the one or more thermopiles are configured to measure at different positions distributed over the mixing chamber length.

3. The method according to claim 2, wherein the mixing chamber has a volume selected from the range of 5-200 μl.

4. The method according to claim 2, wherein after filling the mixing chamber with a volume equal to the volume of the mixing chamber with the calibration liquid mixture, flows of the calibration liquids to the mixing chamber is terminated and said heat is measured by said thermopiles.

5. The method according to claim 1, wherein the microfluidic calorimeter further comprises a mixing element, wherein the mixing element comprises one or more of a multi-lamination micromixer, a chaotic mixer, and a split-and-recombine mixer.

6. The method according to claim 1, comprising sequentially providing a series of calibration liquids having different concentrations of the first compound to the microfluidic calorimeter, measuring the heat by the thermopiles thereby providing corresponding thermopile signals, and calibrating the chip-based microfluidic calorimeter by relating the thermopile signals to reference data of the deprotonating reaction.

7. The method according to claim 1, wherein the method further comprises thermally equilibrating the calibration liquids prior to providing said calibration liquid mixture.

8. The method according to claim 1, wherein the reference data of the deprotonating reaction are based on isothermal titration calorimetry.

9. The method according to claim 8, wherein the method further comprises executing a further calibration method with the calibration liquids, wherein the further calibration method comprises isothermal titration calorimetry, for generating said reference data.

10. The method according to claim 1, wherein the reference data comprise kinetic reference data.

11. The method according to claim 1, wherein the phosphate group comprises phosphate (PO₄³⁻).

12. The method according to claim 1, wherein the buffer comprises 3-(N-morpholino)propanesulfonic acid (MOPS) and wherein the first compound comprises ATP.

13. A chip based microfluidic calorimeter calibrated according to the method according to claim 1.

14. Use of a chip-based microfluidic calorimeter according to claim 13, for measuring an enzymatic activity.

15. A calibration kit comprising a set calibration liquids comprising (i) a buffer with a pH range of at least 7-9, and (ii) a first compound with a phosphate group which is protonated in a pH range of at least 3-6, and optionally a manual for calibrating a chip based microfluidic calorimeter with the set of calibration liquids.

16. The calibration kit according to claim 15, comprising a first container comprising a first calibration liquid comprising said buffer, and comprising a plurality of second containers comprising said first compound, wherein each second container comprises a second calibration liquid with mutually different concentrations of said first compound.

17. The calibration kit according to claim 15, wherein the buffer comprises 3-(N-morpholino)propanesulfonic acid (MOPS) and wherein the first compound comprises ATP.
